(19) United States
(12) Patent Application Publication
(10) Pub. No.: US 2023/0089030 A1
(43) Pub. Date: Mar. 23, 2023

(54) Method for Producing an Electrode

(71) Applicant: Bayerische Motoren Werke Aktiengesellschaft, Muenchen (DE)

(72) Inventors: Sung-Jin KIM, Muenchen (DE); Thomas WOEHRLE, Muenchen (DE)

(21) Appl. No.: 17/802,041

(22) PCT Filed: Feb. 2, 2021
(86) PCT No.: PCT/EP2021/052356

§ 371 Date: Aug. 24, 2022

(30) Foreign Application Priority Data
Feb. 27, 2020 (DE) 10 2020 105 155.7

(51) Int. Cl. H01M 4/04; H01M 10/0525

(52) U.S. Cl. CPC H01M 4/0404; H01M 4/0435; H01M 10/0525; H01M 2220/20

(57) ABSTRACT

A method for producing an electrode, especially for a lithium-ion battery, includes coating a carrier material, machining the carrier material to produce at least one single sheet, and adjusting the porosity of the electrode at the single sheet level.

### FIELD

The present invention relates to a method for producing an electrode for an energy storage cell, in particular for a lithium ion battery or a lithium ion accumulator, to an electrode, to an electrode stack, to an energy storage unit and to a traction battery.

### BACKGROUND AND SUMMARY

The electrodes in question are in particular single sheet electrodes, such as are used in electrode stacks. The electrodes are formed by coated films. After the coating and drying, the electrode is compacted, particularly in order to adjust a porosity, for example by a calender process, cut to target width (for example with rotary shears) and then divided into single sheets after carrying out a contour cut, and optionally stacked. During the calendering, the problem often arises that undesired deformations occur in all regions of the films. Particularly in the uncoated regions of the carrier film, for example folds which lead to quality losses, and inter alia make further processing of the films more difficult, occur because of the application of force. Because of the preliminary damage, cracks, corrugations and the like may thus be formed in downstream process steps, for example when trimming the films. Film cutting by means of a laser may also be made more difficult since it is not possible to focus correctly. In order to counteract these problems, EP 2 296 209 A1 proposes heating of the uncoated regions of the carrier film. DE 10 2017 215 143 A1 uses a metal film which, when it is spread out in a web plane as a web, has a curvature lying in the web plane. This curvature is removed by a corresponding pressure application during the calendering, the aforementioned undesired deformation effect not being intended to be present in the final material. The known approaches, however, are very elaborate in terms of manufacturing technology and are cost-intensive.

It is therefore an object of the present invention to provide a method for producing an electrode, an electrode, an electrode stack, an energy storage unit and a traction battery, which do not have the aforementioned problems.

This object is achieved by a method, an electrode, an electrode stack, an energy storage unit and a traction battery according to the present disclosure. Further advantages and features may also be found from the description and the appended figures.

According to the invention, a method for producing an electrode, particularly a composite electrode, in particular for an energy storage cell, such as for example a lithium ion cell, comprises the steps:
coating a carrier material in order to produce or generate an electrode, in particular with a coating compound;
processing the carrier material in order to produce at least one single sheet;
adjusting the porosity of the electrode on the single sheet.

Advantageously the conventional process chain, according to which the carrier material is initially coated and its compacting to adjust the porosity is then carried out, is modified. In particular, the carrier material is coated on one or both sides with a coating compound. According to one embodiment, the coating compound comprises an active material, electrode binder, conductive carbon black (optionally conductive graphite) and carrier solvent. Compacting, or adjustment of the porosity of the electrode, therefore does not take place until after the carrier material (for example in the form of a metal film) has been trimmed according to the footprint of the cell. The carrier material is, in particular, a carrier film. Depending on whether the electrode is an electrode for the anode or the cathode, the material of the carrier film is selected accordingly. In the case of the anode, the carrier film is typically a copper film, and in the case of the cathode the carrier film is typically an aluminum film. Preferred film thicknesses vary, depending on the cell design, for example between 6 µm and 25 µm. The aluminum film is preferably rolled. The copper film is preferably rolled or electrolytically produced. The carrier films are not limited, and may also be stamped films or expanded metals in any desired geometry. The carrier material or carrier film is coated on one or two sides. This is done for example with suitable application tools such as slot dies, blades, anilox rolls, etc. As an alternative, the carrier material may also be a plastic film which is coated in a suitable way, for example with a metal. By the adjustment of the porosity of the electrode on the single sheet, the aforementioned disadvantages or problems, such as the crack formation mentioned, the folding, etc. are avoided.

Preferably, the electrode is configured as a cathode or anode for a lithium ion cell. The aforementioned cell type does not, however, represent a restriction. Alternative applications, for example for lithium-sulfur cells, are also preferred.

According to one embodiment, the method comprises the step:

processing by cutting out or trimming by means of a thermal or mechanical cutting method.

Preferred mechanical cutting methods are inter alia shearing, stamping, particle cutting or water jet cutting. A preferred thermal cutting method is, for example, laser cutting. According to one embodiment, the cutting out or trimming is carried out near net shape. As an alternative, the desired net shape may already be produced in this step, in particular exactly.

According to one embodiment, the carrier material is configured in the form of a web or is in the form of a web. According to one embodiment, the carrier material is strip-shaped and is coated continuously or intermittently. A multiplicity of coated strips may also be formed along a web direction of the carrier material. In the case of intermittent coating, a size of the coated area preferably corresponds exactly or substantially to the size of the single sheet.

According to one embodiment, the method comprises the step:

processing the carrier material along the coated regions.

In this embodiment, no cutting through the coating or coating compound advantageously takes place, so that very clean cutting edges can be produced.

According to one embodiment, the method comprises the step:

forming a lead region during the processing of the carrier material.

Expediently, the single sheet is shaped together with the lead region. Advantageously, this step may be carried out in such a way that the lead region does not have a coating. As an alternative, a possibly existing coating may also be removed subsequently.

According to one embodiment, the method comprises the step:

shaping a lead region after the adjustment of the porosity.

In this embodiment, for example, the single sheet is trimmed in such a way that one or two uncoated regions, in particular strips, remain free peripherally. This may be advantageous in relation to handling of the single sheet, since these regions, apart from the lead region, are later removed. Thus, it is readily possible to use a machine device in this case, for example a robot or the like, with a gripper etc. In this case, the uncoated regions are advantageously configured to be so narrow that no problems occur during the subsequent adjustment of the porosity, for example by means of calendering.

According to one embodiment, the method comprises the step:

adjusting the porosity by pressing and/or rolling.

During pressing, the pressure is applied perpendicularly or substantially perpendicularly, or in a normal direction, onto the single sheet, on one or both sides. For this purpose, corresponding presses or pressing dies may be used. Very non-invasive processing may therefore advantageously be achieved. According to one embodiment, rolling is carried out in a calender.

According to one embodiment, the method comprises the step:

rolling along different rolling directions.

The rolling may, for example, be carried out in a calender. Since this is not a conventional roll-to-roll process, no mechanical stress takes place on the electrode, or the single sheet, due to tensile forces. The risk of tearing the single sheet or the uncoated regions is therefore substantially eliminated. According to one embodiment, at least one calender roll is heated in order to facilitate the compacting.

Particularly advantageously, it is thereby possible to achieve greater compression of the electrode and therefore to achieve a higher electrode density. Consequently, higher powers and higher energy densities can be achieved with such electrodes.

Particularly advantageously, in the present case it is also possible to roll along different rolling directions, or to combine different compacting methods, for example first compacting with a die tool and then compacting by means of rolls in a calender. In this case, the aforementioned rolling directions may for example be perpendicular or substantially perpendicular to one another, in order to compensate for any deformations.

According to one embodiment, the method comprises the step:

moving or transporting the single sheets by means of suction pads.

For the removal and feed of the uncoated and coated single sheets, which may for example be temporarily stored in magazines, it is possible to use suction pads, which may also be automated with robotics.

According to one embodiment, the method comprises the step:

moving or transporting the single sheets by means of transport films.

According to one embodiment, the single sheets are guided and positioned on a polyester film, and according to one embodiment they are also specially protected, in particular mechanically and thermally, between two polyester films.

According to one embodiment, the method comprises the step:

coating the single sheet by a method selected from one of the following: lamination, adhesive bonding, masking, extrusion, dry coating, wet coating, direct wet coating, etc.

After the coating, a drying process is generally carried out. In the case of wet coating, the so-called carrier solvent (for example water) is in this case extracted. In general, vacuum drying in which the residual moisture in the electrode is reduced then follows.

According to one embodiment, the method comprises the step:

recutting the single sheet after the adjustment of the porosity.

According to one embodiment, the final shape of the single sheet, in other words its net shape, is produced in this step. As already indicated, this method step may also be configured in such a way that the lead region is thereby also formed. The mechanical and/or thermal cutting methods already mentioned are preferably used for the cutting.

The invention also relates to an electrode, in particular a composite electrode, in particular for an energy storage cell, a lithium ion battery or a lithium ion accumulator, comprising a carrier material which has single sheet dimensions, and wherein the carrier material has a coating which is uncompacted. In particular it is an uncompacted single sheet electrode. The electrode preferably has no uncoated region, or only a very small uncoated region. The risk of tearing the electrode, or the positions on the carrier material which are not coated, therefore no longer exists and greater compression of the electrode and therefore the achievement of a higher electrode density are made possible. It has been found that such an electrode can be processed further very well.

The invention also relates to an electrode stack comprising a multiplicity of electrodes, cathodes and anodes, produced by the method according to the invention and arranged in the form of a stack. In order to make an electrode stack, the electrodes are used together with a separator. All known separators may be made and applied to form a single sheet.

According to one embodiment, the electrode stack is configured as a single sheet stack. As an alternative, the electrode stack is configured as a double-cell stack.

The invention furthermore relates to an energy storage unit comprising an electrode stack according to the invention. The energy storage unit may, according to one embodiment, be a lithium ion cell or a lithium-sulfur cell.

According to one embodiment, the energy storage unit comprises a solid cell housing, which in particular has a prismatic shape. As an alternative, the energy storage unit may be configured as a pouch bag or soft pack, which is soft packaging consisting of highly processed composite aluminum film. Alternative cell housing forms are likewise possible. In principle, the stacking of the electrodes allows extremely highly efficient use of an angular, in particular cubic or cuboid, cell housing, cf. in particular the aforementioned prismatic cell housing.

The invention furthermore relates to a traction battery comprising at least one energy storage unit according to the invention. The traction battery is preferably designed for use in a motor vehicle such as an automobile, a motorcycle or a commercial vehicle.

Further features and advantages may be found from the following description of embodiments of methods with reference to the appended figures. Different features may in this case be combined with one another in the scope of the invention.

### BRIEF DESCRIPTION OF THE DRAWINGS

FIG. 1 shows a schematic representation of one embodiment of a method sequence according to the invention for producing an electrode; and

FIG. 2 shows a schematic representation of an alternative method sequence according to one embodiment of the method according to the invention.

### DETAILED DESCRIPTION

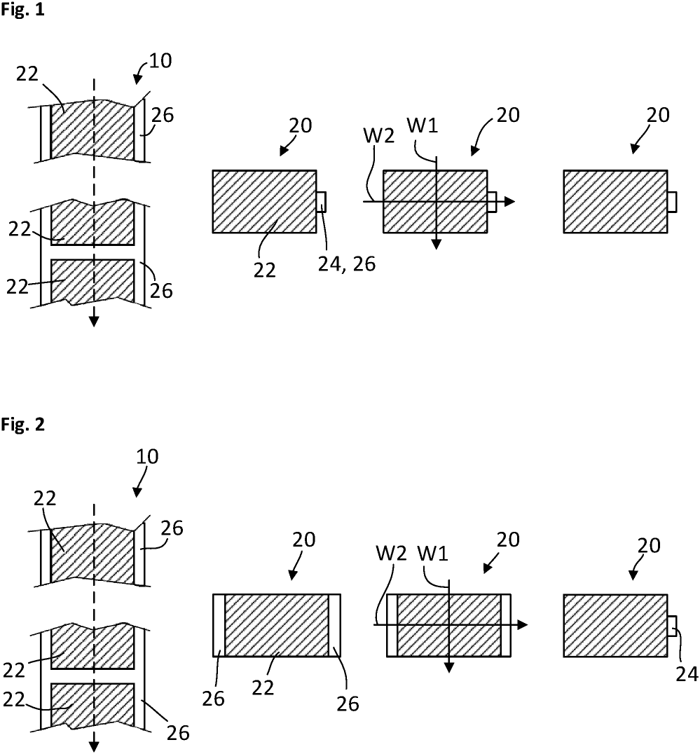

FIG. 1 shows on the left two embodiments of carrier materials or carrier films 10, which extend along a web direction B. The upper variant is coated in the shape of a strip, cf. the reference 22, and the lower variant is coated in the shape of a strip and intermittently along the web direction B. The uncoated regions are outlined with the reference 26. Compacting has not yet been carried out, that is to say a porosity of the electrode has not yet been adjusted. Expediently, single sheets are produced from such carrier materials 10, cf. the reference 20. In the embodiment represented here, a lead region 24 is in this case automatically formed jointly. The adjustment of the porosity of the electrode(s), or the compacting or pressing, do not take place until in a subsequent step, that is to say advantageously directly on the single sheet 20. The references W1 and W2 denote by way of example two rolling directions. Compacting along different directions increases the process stability, since any deformations can be compensated for optimally. After the pressing or compacting of the electrodes, recutting of the single sheet 20 to net shape is optionally carried out in a final step. This step may also be omitted however, depending on the embodiment. For the case in which the lead region 24 is coated, it may likewise be exposed subsequently.

FIG. 2 shows an alternative embodiment of a method for producing an electrode, the essential steps being known from FIG. 1. One crucial difference is that a lead region 24 is not already jointly produced when producing a single sheet 20 from a carrier film 10. Instead, the lead region 24 is not produced until in a final processing step. The single sheet 20 initially has strip-shaped uncoated regions 26. These may advantageously be used to handle the single sheet 20 better in the process. In this case, the uncoated regions 26 are configured to be so small that no folds, cracks or the like occur during the pressing, compacting or calendering.

### List of References

| | |
|---|---|
| 10 | carrier material, carrier film |
| 20 | single sheet |
| 22 | coating, coating compound |
| 24 | lead region |
| 26 | uncoated region |
| W1 | first rolling direction |
| W2 | second rolling direction |
| B | web direction |

1-15. (canceled)

16. A method for producing an electrode for an energy storage cell, comprising:
coating a carrier material;
processing the carrier material in order to produce at least one single sheet; and
adjusting a porosity of the electrode on the single sheet.

17. The method according to claim 16, comprising:
processing by cutting out or trimming by means of a thermal or mechanical cutting method.

18. The method according to claim 16,
wherein the carrier material is coated only locally, and
wherein the method further comprises:
processing the carrier material along the coated regions.

19. The method according to claim 16, comprising:
forming a lead region during the processing of the carrier material.

20. The method according to claim 16, comprising:
shaping a lead region after the adjustment of the porosity.

21. The method according to claim 16, comprising:
adjusting the porosity by pressing and/or rolling.

22. The method according to claim 21, comprising:
rolling along different directions.

23. The method according to claim 16, comprising:
moving the single sheets by means of suction pads.

24. The method according to claim 16, comprising:
moving or transporting the single sheets by means of transport films.

25. The method according to claim 16, comprising:
recutting the single sheet after the adjustment of the porosity.

26. The method according to claim 16, comprising:
coating the single sheet by a method selected from at least one of the following: lamination, adhesive bonding, masking, extrusion, dry coating, wet coating, or direct wet coating.

27. An electrode, comprising:
a carrier material that has single sheet dimensions,
wherein the carrier material has a coating which is uncompacted.

28. An electrode stack comprising a plurality of electrodes arranged in the form of a stack, produced by the method according to claim 16.

29. An energy storage unit comprising the electrode stack according to claim 28.

30. A traction battery comprising the energy storage unit according to claim 29.
